(19) United States
(12) Patent Application Publication
(10) Pub. No.: US 2016/0086389 A1
(43) Pub. Date: Mar. 24, 2016

(54) METHODS AND SYSTEMS FOR PROCESSING SPEECH TO ASSIST MAINTENANCE OPERATIONS

(71) Applicant: HONEYWELL INTERNATIONAL INC., Morristown, NJ (US)

(72) Inventors: Dinkar Mylaraswamy, Fridley, MN (US); Brian H. Xu, Plymouth, MN (US); Harold Carl Voges, Shoreview, MN (US); Chaya Garg, Plymouth, MN (US); Robert E. De Mers, Nowthen, MN (US)

(73) Assignee: HONEYWELL INTERNATIONAL INC., Morristown, NJ (US)

(21) Appl. No.: 14/492,252

(22) Filed: Sep. 22, 2014

(51) Int. Cl. G07C 5/00; G10L 15/18

(52) U.S. Cl. CPC G07C 5/006; G10L 15/1815

(57) ABSTRACT

Methods and systems are provided for recording natural conversation of a user of a vehicle. In one embodiment, a method includes: recognizing speech from the recording; processing the recognized speech to determine a meaning associated with the speech; identifying a category of the speech based on the meaning; and generating a maintenance report to be used by a maintainer of the vehicle based on the category and the speech.

### TECHNICAL FIELD

The present disclosure generally relates to methods and systems for processing speech, and more particularly relates to methods and systems for processing speech in order to assist maintenance operations.

### BACKGROUND

Observations made by flight crew members such as smoke, smell, resets of electronic devices, and directions provided by the ground/air traffic controllers can aid an aircraft maintainer when trouble-shooting a condition of the aircraft. Typically, aircraft maintenance is driven by primarily by sensor data captured and analyzed by on-aircraft recorders. Observations made by the maintainer during pre-flight and post flight examinations may also be used. Any flight deck effects (observations by the flight crew while the plane is operational) are typically recorded manually by the crew member after the flight. These observations, also referred to as squawks, are communicated to the maintainer using hand-written paper notes or summarized digitally. In both cases, the quality of the communications is limited for the following reasons: (a) since the notes are written at the end of the flight, only significant flight deck effects are typically remembered and transcribed; (b) the timeline associated with the observations is approximate; and (c) since manual typing is laborious, auxiliary details are may not be captured.

Thus, it is desirable to improve the communication flight deck effects observed by the flight crew without increasing the workload of crew members. Hence, there is a need for systems and methods for processing speech in order to assist maintenance operations. Other desirable features and characteristics will become apparent from the subsequent detailed description and the appended claims, taken in conjunction with the accompanying drawings and the foregoing technical field and background.

### BRIEF SUMMARY

Methods and systems are provided for speech processing. In one embodiment, a method includes: recognizing speech from the recording; processing the recognized speech to determine a meaning associated with the speech; identifying a category of the speech based on the meaning; and generating a maintenance report to be used by a maintainer of the vehicle based on the category and the speech.

In another embodiment, a system includes: an input device that records a natural conversation of a user of a vehicle; and a processor that recognizes speech from the recording, that processes the speech to determine a meaning of the speech, that identifies a category of the speech based on the meaning, and that generates a maintenance report to be used by a maintainer of the vehicle based on the category and the speech.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following figures, wherein like numerals denote like elements, and wherein:

FIG. 1 is a functional block diagram illustrating a speech processing system for a vehicle in accordance with exemplary embodiments;

FIG. 2 is dataflow diagram illustrating modules of the speech processing system in accordance with exemplary embodiments; and

FIGS. 3 and 4 are flowcharts illustrating speech processing methods that may be performed by the speech processing system in accordance with exemplary embodiments.

### DETAILED DESCRIPTION

The following detailed description is merely exemplary in nature and is not intended to limit the disclosure or the application and uses of the disclosure. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

In accordance with various embodiments, speech processing systems are disclosed for capturing and processing speech, in particular, speech from a natural conversation of a user of a vehicle. The speech processing system generally provides diagnostic information based on the processing.

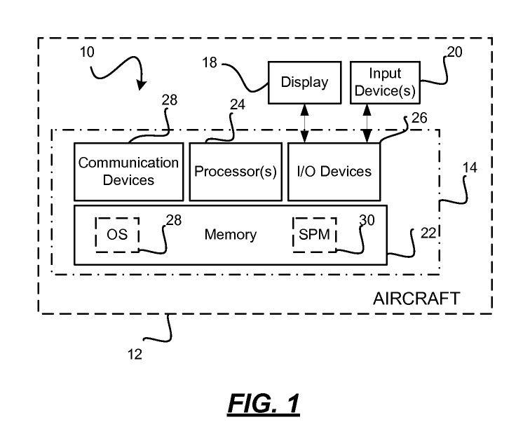

Referring now to FIG. 1, exemplary embodiments of a speech processing system shown generally at 10 that is associated with a vehicle, such as an aircraft 12, is shown and described. As can be appreciated, the speech processing system 10 described herein can be implemented in any aircraft 12 or other vehicle having onboard a computing device 14 that is associated with the speech system 10 that is configured to receive and process speech input from a crew member or other user. The computing device 14 may be associated with a display device 18 and one or more input devices 20 and may generally include a memory 22, one or more processors 24, one or more input/output controllers 26 communicatively coupled to the display device 18 and the one or more input devices 20, and one or more communication devices 28. The input devices 20 include, for example, an audio recording device.

In various embodiments, the memory 22 stores instructions that can be performed by the processor 24. The instructions stored in memory 22 may include one or more separate programs, each of which comprises an ordered listing of executable instructions for implementing logical functions. In the example of FIG. 1, the instructions stored in the memory include an operating system (OS) 28 and a speech processing module (SPM) 30.

The operating system 28 controls the performance of other computer programs and provides scheduling, input-output control, file and data management, memory management, and communication control and related services. When the computing device 14 is in operation, the processor 24 is configured to execute the instructions stored within the memory 22, to communicate data to and from the memory 22, and to generally control operations of the computing device 14 pursuant to the instructions. The processor 24 can be any custom made or commercially available processor, a central processing unit (CPU), an auxiliary processor among several processors associated with the computing device 14, a semiconductor based microprocessor (in the form of a microchip or chip set), a macroprocessor, or generally any device for executing instructions.

The processor 24 executes the instructions of the speech management module 30 of the present disclosure. The speech management module 30 generally captures and processes speech recorded by the audio recording device 20 during a natural conversation of a user of the aircraft 12, and generates information for use in diagnosing conditions of the aircraft 12. The speech management module 30 communicates reports that include the information via the one or more communication devices 28.

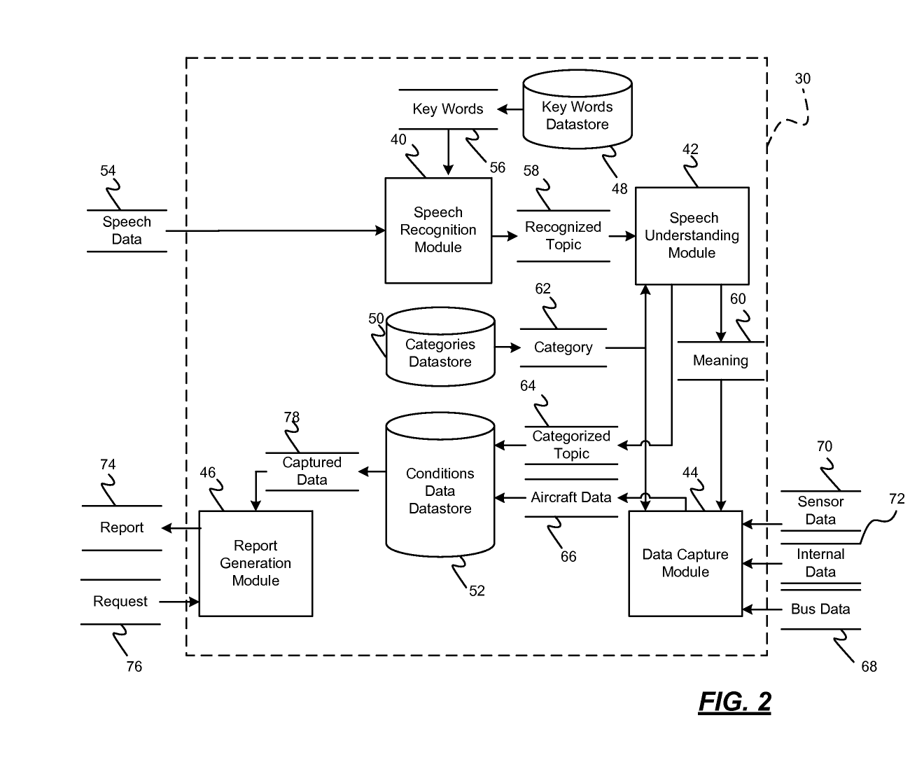

Referring now to FIG. 2 and with continued reference to FIG. 1, a dataflow diagram illustrates various embodiments of the speech processing module 30. Various embodiments of speech processing modules 30 according to the present disclosure may include any number of sub-modules embedded within the speech processing module 30. As can be appreciated, the sub-modules shown in FIG. 2 may be combined and/or further partitioned to process speech. The inputs to the speech processing module 30 may be received from other modules (not shown), determined/modeled by other sub-modules (not shown) within the speech processing module 30, and/or received from the input devices 20 or a communication bus. In various embodiments, the speech processing module 30 includes a speech recognition module 40, a speech understanding module 42, a data capture module 44, a report generation module 46, a key words datastore 48, a categories datastore 50, and a conditions data datastore 52.

The speech recognition module 40 receives as input speech data 54 that includes speech spoken by one or more users of the aircraft 12 during natural conversation and that was captured by the audio recording device 20. The speech recognition module 40 processes the speech data 54 based on one or more speech recognition techniques known in the art to recognize words spoken by the one or more uses of the aircraft 12.

The speech recognition module 40 further processes the recognized words for specific key words 56. In various embodiments, the key words 56 may be learned (e.g., in real time or by processing data offline) and stored in the key words datastore 48. In various embodiments, the key words 56 are words that typically indicate a discussion of a condition of the aircraft 12 (e.g., cross bleed valve, oil temperature, squealing noise, odor, smell, etc.). If in fact a key word or words 56 is identified within the speech data 54, a recognized topic 58 (e.g., the one or more sentences containing the key word or words 56) is presented to the speech understanding module 42 for further processing. If, however, no key words are identified in the speech data 54, the speech data 54 and/or the recognized speech may be discarded or logged but need not be further processed.

The speech understanding module 42 receives as input the recognized topic 58 that includes the key word or words 56 that were identified. The speech understanding module 42 processes the recognized topic 58 based on one or more speech understanding techniques. The speech understanding module 42 processes the recognized topic 58 to identify a meaning 60 of the topic 58. For example, the conversation may be associated with air traffic control (ATC) clearance, equipment failure, landing without clearance, a runway incursion, an air space violation, fumes, or any other condition associated with the aircraft 12.

Based on the meaning 60, the speech understanding module 42 categorizes the recognized topic 58. For example, if the recognized topic 58 has a specific meaning 60, the topic 58 is associated with a particular category 62. In various embodiments, categories 62 may be learned (e.g., in real time or by processing data offline) and stored in the categories datastore 50. The category 62 identifies an element of a condition of the aircraft 12 and may be for example, start air valve stuck open, start engine light illumination is not resetting, sluggish actuator for the landing gear, engine starting too slow, auto pilot is disengaging intermittently, or any other element. The speech understanding module 42 stores the categorized topic 64 in the conditions data datastore 52.

The data capture module 44 receives as input the category 62 and/or the meaning 60 associated with the topic 58. The data capture module 44 determines aircraft data 66 that may be associated with the meaning 60 and/or the category 62 at a time associated with an occurrence of the speech data 54. For example, the data capture module 44 monitors data 68 communicated on various data buses, monitors data 70 from various sensors, and/or monitors data 72 internal to the computing device 14. For example, the data capture module 44 monitors the data 68-72 from the sources at a time before, during, and/or after the occurrence of the conversation. The data capture module 44 captures the data 68-72 from the sources that relate to or is associated with the category 62 and/or the meaning 60 of the recognized topic 58. The data capture module 44 associates the aircraft data 66 with the recognized topic 58 and stores the aircraft data 66 in the conditions data datastore 52.

The report generation module 46 generates reports 74 based on the topics 64 and the aircraft data 66 stored in the conditions data datastore 52. In various embodiments, the report generation module 46 generates the reports 74 based on a request 76 for a report that is initiated by a user or other system. In various other embodiments, the report generation module 46 generates the reports automatically based on an occurrence of an event or at a predetermined time.

In various embodiments the report 74 can include sections and the sections of the report 74 may be populated based on the topics associated with a category that is associated with the section. For example, the sections may include, but are not limited to, symptoms observed, an aircraft subsystem exhibiting the symptom, the severity of the problem, and/or an explanation for the symptom. The symptoms observed section may be related to a non-critical equipment failure and may include, for example, the conversation related to a trim air valve showing intermittent behavior and information indicating that symptom was observed during the climb phase of the aircraft and that the aircraft subsystem during this conversation exhibited the certain sensor values.

In various embodiments, the report generation module 46 provides the report or parts of the report as a digital signal (or other type of signal). For example, the report generation module 46 populates a digital form and the digital form may be included in digital signals that are presented visually to a user of the aircraft 12 (e.g., a pilot or other crew member) for acknowledgement (e.g., via the display 18). In another example, the digital form is included in digital signals and communicated on an aircraft data bus using a predefined protocol. In another example, the digital form is included in digital signals and communicated as an email/text message for receipt by a maintainer. In still another example, the digital form is included in digital signals that are communicated to a remote computer and archived.

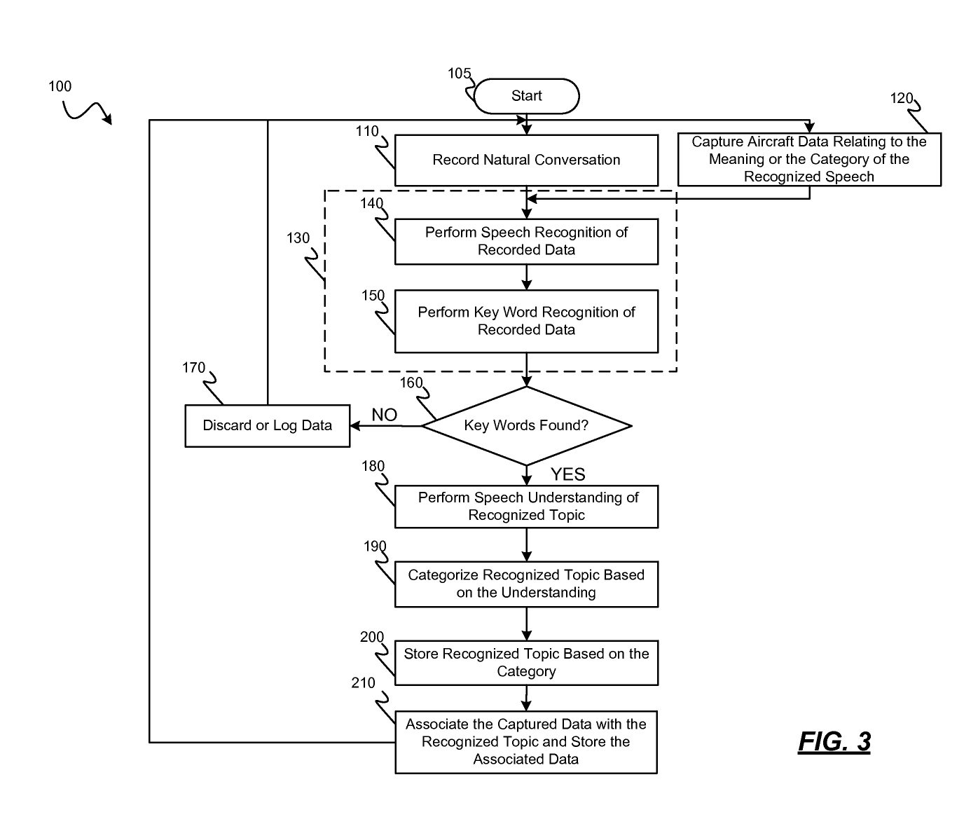

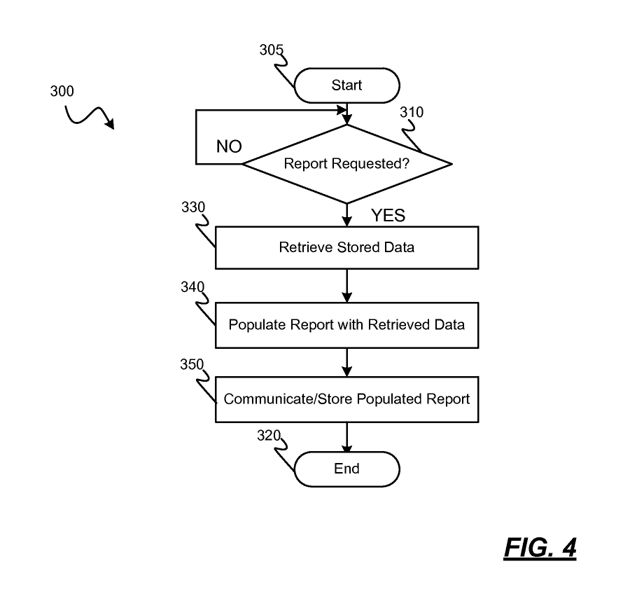

Referring now to FIGS. 3 and 4, and with continued reference to FIGS. 1 and 2, flowcharts illustrate methods that may be performed by the speech processing system 10 in accordance with the present disclosure. As can be appreciated in light of the disclosure, the order of operation within the methods is not limited to the sequential execution as illustrated in FIGS. 3 and 4, but may be performed in one or more varying orders as applicable and in accordance with the present disclosure.

In various embodiments, the methods can be scheduled to run based on predetermined events, and/or can run continually during operation of the computing device 14 of the aircraft 12.

In FIG. 3, a method 100 of processing speech data from a natural conversation is shown. The method 100 may begin at 105. The recording device 20 records natural conversation of users of the aircraft 12 at 110. Aircraft data 66 is captured at the same time of the recording of the conversation, before the recording, and/or after the recording at 120. The speech data 54 generated from the recording is processed at 130. In particular, speech recognition is performed on the recorded data at 140; and key word recognition is performed on the recognized speech at 150.

If no key words are recognized in the speech, the recorded data 54 and the captured data 66 is discarded and/or logged at 170. Thereafter, the method continues with recording conversation and capturing data at 110 and 120.

If, however, at least one key word 56 is recognized at 160, speech understanding is performed on the topic 58 including the recognized speech to determine a meaning of the topic 58 at 180. The recognized topic 58 is then categorized based on the meaning at 190. The categorized topic 64 is stored at 200 and the captured data 68-72 is associated with the categorized topic 64 and stored at 210. Thereafter, the method continues with recording conversation and capturing data at 110 and 120.

In FIG. 4, a method 300 of reporting the data is shown. The method 300 may begin at 305. It is determined whether a report of the data is requested (e.g., based on a user or system initiated request 76, or automatically based on a scheduled event or time) at 310. If a report is not requested, the method may end at 320. If, however, a report is quested at 310, the stored data 78 is retrieved from the conditions data datastore 52 at 330, for example, based on the category or other criteria associated with the stored data. The report form is populated with the stored data 78, for example, based on the associated category at 340. The report form is then communicated and/or stored at 350. Thereafter, the method may end at 320.

Those of skill in the art will appreciate that the various illustrative logical blocks, modules, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of speech processing, comprising:
recording natural conversation of a user of a vehicle;
recognizing speech from the recording;
processing the recognized speech to determine a meaning associated with the speech;
identifying a category of the speech based on the meaning; and
generating a maintenance report to be used by a maintainer of the vehicle based on the category and the speech.

2. The method of claim 1, further comprising processing the speech to recognize key words, and wherein the processing the speech to determine the meaning comprises processing the speech having the key words to determine the meaning of the speech.

3. The method of claim 1, further comprising storing the speech based on the category.

4. The method of claim 1, further comprising generating signals including the report and communicating the signals.

5. The method of claim 4, wherein the communicating comprises communicating the signals by at least one of email and text message.

6. The method of claim 4, wherein the communicating comprises communicating the signals on a data bus.

7. The method of claim 4, wherein the communicating comprises communicating the signals to a remote server.

8. The method of claim 1, wherein the generating the report comprises generating a report having multiple sections and wherein the multiple sections are populated with the speech based on categories associated with the sections.

9. The method of claim 1, wherein the vehicle is an aircraft and wherein the method further comprises capturing aircraft data at least one of before, during, and after an occurrence of the natural conversation.

10. The method of claim 9, further comprising associating the aircraft data with at least one of the speech and the category and storing the aircraft data based on the at least one of speech and the category.

11. The method of claim 1, wherein the key words are mapped to a discussion of a condition of an aircraft.

12. The method of claim 1, wherein the category identifies an element of a condition of an aircraft.

13. A system for managing for speech processing, comprising:
an input device that records a natural conversation of a user of a vehicle; and
a processor that recognizes speech from the recording, processes the speech to determine a meaning of the speech, identifies a category of the speech based on the meaning, and generates a maintenance report to be used by a maintainer of the vehicle based on the category and the speech.

14. The system of claim 13, wherein the processor processes the speech to recognize key words, and processes the speech having the key words to determine the meaning of the speech.

15. The system of claim 13, wherein the processor stores the speech based on the category.

16. The system of claim 13, wherein the processor generates signals including the report and communicates the signals.

17. The system of claim 13, wherein the processor generates a report having multiple sections populates the multiple sections with the speech based on categories associated with the multiple sections.

18. The system of claim 13, wherein the vehicle is an aircraft and wherein the processor captures aircraft data at least one of before, during, and after an occurrence of the natural conversation, and associates the aircraft data with at least one of the speech and the category and storing the aircraft data based on the at least one of speech and the category.

19. The system of claim 13, wherein the key words indicate a discussion of a condition of an aircraft.

20. The system of claim 13, wherein the category identifies an element of a condition of an aircraft.
